(19) United States
(12) Patent Application Publication
(10) Pub. No.: US 2011/0176324 A1
(43) Pub. Date: Jul. 21, 2011

(54) VEHICULAR LAMP USING PLANAR LIGHT-EMITTING BODY FOR SUB LIGHT SOURCE

(75) Inventor: Kazunori Natsume, Shizuoka (JP)

(73) Assignee: KOITO MANUFACTURING CO., LTD., Tokyo (JP)

(21) Appl. No.: 13/009,248

(22) Filed: Jan. 19, 2011

(30) Foreign Application Priority Data
Jan. 21, 2010 (JP) 2010-011056

(51) Int. Cl. B60Q 1/04

(52) U.S. Cl. 362/544

(57) ABSTRACT

A vehicular lamp includes a housing covered by a translucent cover so as to form a lamp chamber. A main light source and a sub light source are disposed inside the lamp chamber. The sub light source includes a planar light-emitting body. The planar light-emitting body is arranged in an area off to a side of a light path of the main light source.

### BACKGROUND OF INVENTION

1. Field of the Invention

The present invention relates to a vehicular lamp provided with a main light source and a sub light source inside a lamp chamber.

2. Related Art

Conventionally, as shown in FIG. 5, a vehicular headlamp 51 in which a main light source 55 and a sub light source 56 are provided inside a lamp chamber 54 between a housing 52 and a translucent cover 53 is known. As shown in FIG. 6, the main light source 55 is used as a low-beam lamp 55A and a high-beam lamp 55B, and the sub light source 56 is used as a clearance lamp 56A, a turn signal lamp 56B, and a running lamp 56C. Patent Document 1 describes a vehicular lamp in which a main light source is arranged inside a lamp chamber, an inner lens is arranged on the inside of a translucent cover in front of the main light source, and a planar light-emitting layer as a sub light source is covered by the inner lens.

[Patent Document 1] Japanese Patent Application Laid-Open (Kokai) No. JP-A-2002-216507

### SUMMARY OF INVENTION

However, according to the vehicular lamp in Patent Document 1, the planar light-emitting layer of the sub light source is positioned in front of the main light source, so the sub light source blocks the light from the main light source. In contrast, the vehicular lamp 51 in FIG. 5 and FIG. 6 is such that the main light source 55 and the sub light source 56 are arranged in vertically different positions, so the light will not be blocked. However, by doing so, the entire lamp becomes larger in size. Also, while it is also conceivable to arrange the sub light source 56 in an empty area around the main light source 55 (around the lamps 55A, 55B in FIG. 6), both of the light sources 55, 56 come with parts 57 (see FIG. 5) such as a supporting portion and a lighting circuit and the like, so ensuring sufficient mounting space is difficult.

One or more embodiments of the present invention provide a vehicular lamp in which a sub light source can be compactly arranged in a limited space inside a lamp chamber without blocking the light from a main light source.

In one or more embodiments of the present invention, a vehicular lamp is provided with a main light source and a sub light source in a lamp chamber between a housing and a translucent cover.

In one aspect, embodiments of the present invention relate to a vehicular lamp characterized in that the sub light source includes a planar light-emitting body, and the planar light-emitting body is arranged in an area off to a side of a light path of the main light source.

In one aspect, embodiments of the present invention relate to a vehicular lamp in which the main light source and the sub light source are arranged in different areas of a common light source base.

In one aspect, embodiments of the present invention relate to a vehicular lamp in which the planar light-emitting body is formed surrounding the main light source.

In one aspect, embodiments of the present invention relate to a vehicular lamp in which the sub light source includes a plurality of planar light-emitting bodies that emit different colors of light.

In one aspect, embodiments of the present invention relate to a vehicular lamp in which organic EL (electroluminescence) is used for the planar light-emitting body.

Embodiments of a vehicular lamp of the present invention may be combined so as to include one or more of the above aspects in any combination. Further, in one or more embodiments, because the planar light-emitting body of the sub light source is arranged in an area off to a side from the light path of the main light source, an effect in which the sub light source can be compactly arranged in a limited space inside the lamp chamber without blocking the light from the main light source is achieved.

Other aspects and advantages of the invention will be apparent from the following description, the drawings and the claims.

### BRIEF DESCRIPTION OF DRAWINGS

FIG. 1 is a front view of a vehicular headlamp showing an embodiment of the present invention.

FIG. 2 is a horizontal cross sectional view showing the internal structure of the vehicular headlamp.

FIG. 3 is a front view of a housing showing a planar light-emitting body of a sub light source.

FIG. 4 is a perspective view of a rear combination lamp showing another embodiment of the present invention.

FIG. 5 is a vertical cross sectional view showing a conventional vehicular lamp.

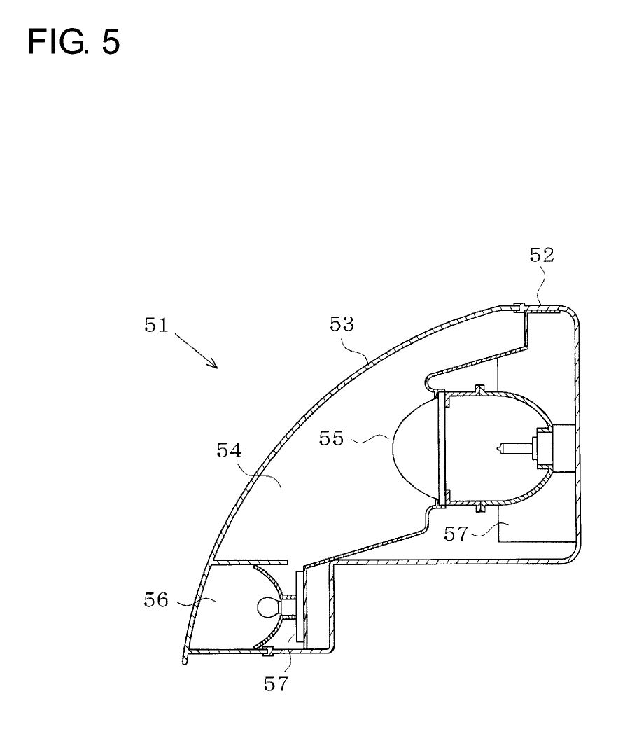

FIG. 6 is a front view showing a conventional vehicular lamp.

### DETAILED DESCRIPTION

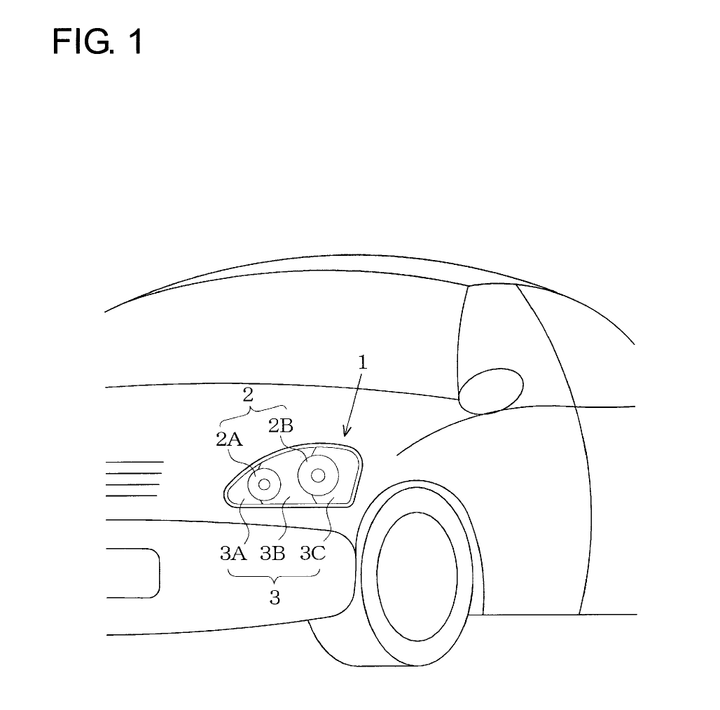

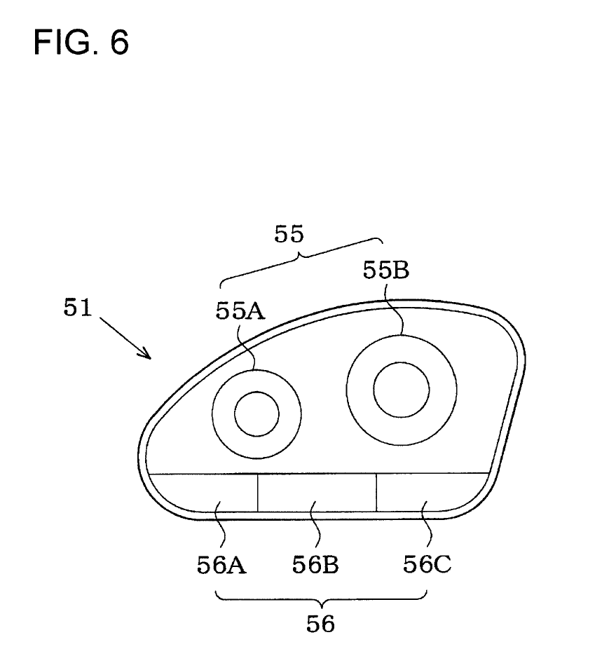

Hereinafter, embodiments of the present invention will be described with reference to the figures. A vehicular headlamp in accordance with one or more embodiments will be described based on FIG. 1 to FIG. 3. As shown in FIG. 1, this vehicular headlamp 1 includes a low-beam lamp 2A and a high-beam lamp 2B as main light sources 2, and is equipped with a clearance lamp 3A, a turn signal lamp 3B, and a running lamp 3C as sub light sources 3. The three sub light sources 3 are provided around the main light sources 2, and the entire headlamp 1 is made small as compared to a conventional lamp (see FIG. 6).

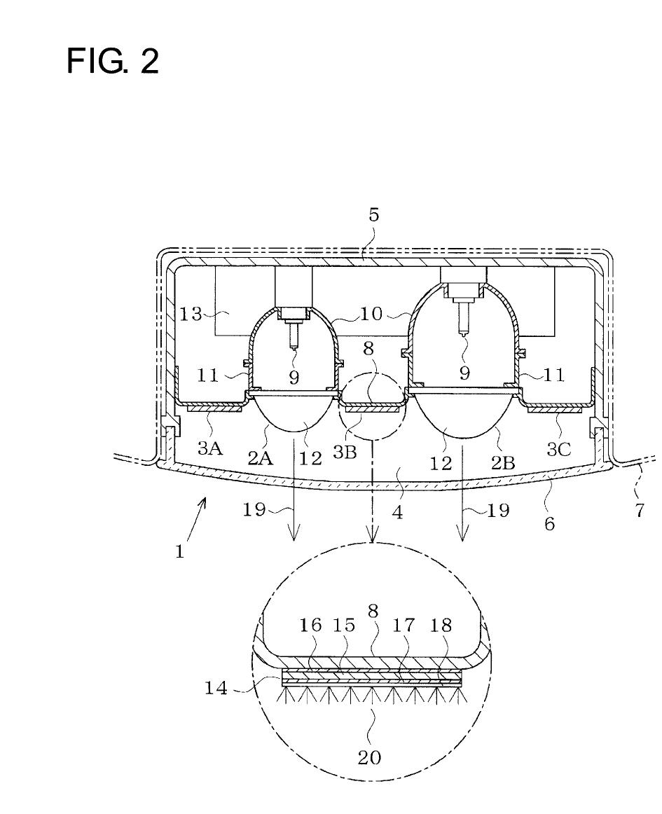

As shown in FIG. 2, a lamp chamber 4 of the vehicular headlamp 1 is formed between a housing 5 and a translucent cover 6. The housing 5 is attached to a vehicle body 7, and the translucent cover 6 covers a front opening of the housing 5. A light source base 8 is provided inside the lamp chamber 4, and the two main light sources 2A, 2B and the three sub light sources 3A, 3B, 3C are arranged lined up in different positions of the common light source base 8. The main light sources 2A, 2B are each formed by a bulb 9, a reflector 10, a lens supporting cylinder 11, a projection lens 12, and a lighting circuit 13 and the like.

A planar light-emitting body 14 made of organic EL is used for each of the sub light sources 3A, 3B, 3C. The planar light-emitting body 14 is formed by laminating a back plate 16 and a transparent electrode 17 to an organic light-emitting layer 15, and overlaying a glass layer 18 on the transparent electrode 17. The planar light-emitting body 14 is attached to the light source base 8 in an area off to a side of light paths 19 of the main light sources 2A, 2B. Then, diffused light 20 produced from the entire surface of the organic light-emitting layer 15 is transmitted through the transparent electrode 17 and the glass layer 18, thus illuminating the translucent cover 6 from inside.

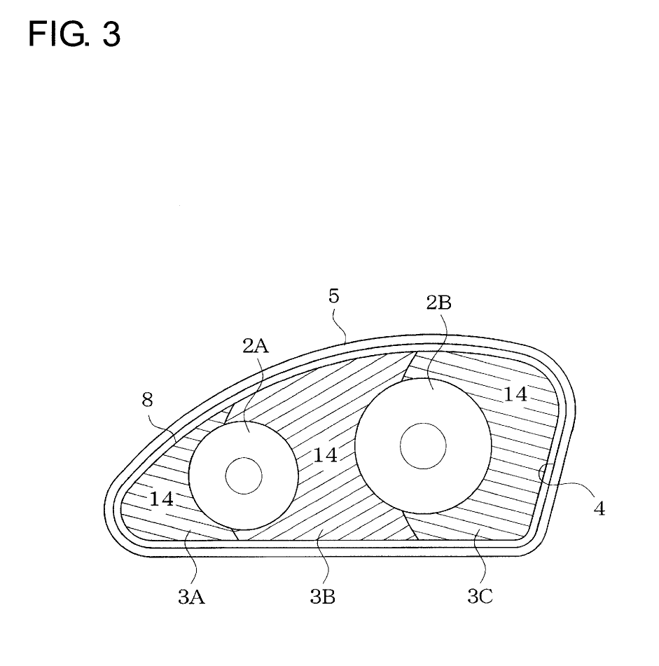

As shown in FIG. 3, the planar light-emitting bodies 14 of the sub light sources 3A, 3B, 3C are provided on the surface of the light source base 8 so as to surround the main light sources 2A, 2B. That is, the low-beam lamp 2A is surrounded by the clearance lamp 3A and the turn signal lamp 3B, and the high-beam lamp 2B is surrounded by the turn signal lamp 3B and the running lamp 3C. Also, the light-emitting layers 15 of the three planar light-emitting bodies 14 are each formed by organic material of a different component. However, the present invention is not limited to the particular configuration illustrated in the drawings. That is, the planar light-emitting bodies 14 may also be partially provided or formed to emit the same color.

According to the vehicular headlamp 1 having the structure described above, effects such as the following can be obtained.

(a) The planar light-emitting bodies 14 are used for the sub light sources 3, so the three lamps 3A, 3B, 3C can be compactly arranged effectively utilizing the empty space of the light source base 8, without being blocked by the projection lenses 12 or the reflectors 10 of the main light sources 2.

(b) The planar light-emitting bodies 14 are arranged in an area off to a side of the light paths 19 of the main light sources 2, so there is no problem of the light from the main light sources 2 being blocked by the sub light sources 3, and the light from the sub light sources 3 will not be blocked by the main light sources 2.

(c) The planar light-emitting bodies 14 are formed surrounding the main light sources 2, so almost all of the area inside the lamp chamber 4 is able to be a light-emitting surface, and an innovative bright design can be created for the headlamp 1 when the sub light sources 3 are lit.

(d) The functionality of the headlamp 1 can be increased by making the emission colors of the planar light-emitting bodies 14 different according to the type of the sub light source 3.

(e) Organic EL is used for the planar light-emitting bodies 14, so high-intensity sub light sources 3 can be thinly provided in the headlamp 1.

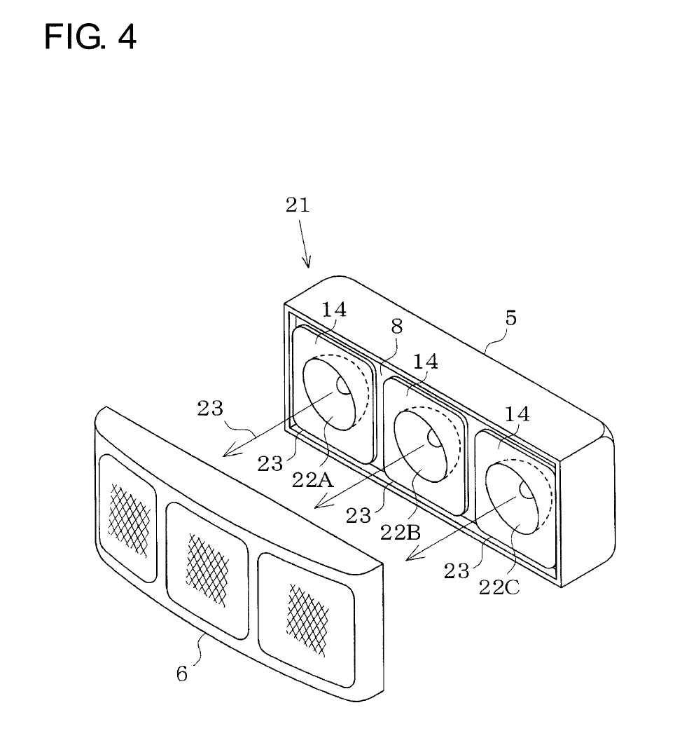

The present invention is not limited to the embodiments described with respect to headlamp 1, and is also able to be applied to various types of vehicular lamps provided at each part of a vehicle. With the rear combination lamp 21, as shown in FIG. 4, three main light sources 22 and the same number of sub light sources 23 are arranged in different positions on the light source base 8. The main light sources 22 are used as a tail/stop lamp 22A, a back lamp 22B, and a turn signal lamp 22C, and the sub light sources 23 are formed surrounding each lamp 22A, 22B, 22C. Then, the planar light-emitting bodies 14 are used for the sub light sources 23, such that diffused light is produced in an area off to a side of the light paths 19 of the main light sources 22.

While description has been made in connection with exemplary embodiments of the present invention, it will be obvious to those skilled in the art that various changes and modification may be made therein without departing from the present invention. It is aimed, therefore, to cover in the appended claims all such changes and modifications falling within the true spirit and scope of the present invention.

### DESCRIPTION OF THE REFERENCE NUMERALS

1 Vehicular Headlamp
2 Main Light Source
3 Sub Light Source
4 Lamp Chamber
5 Housing
6 Translucent Cover
8 Light Source Base
14 Planar Light-Emitting Body
19 Light Path of Main Light Source
21 Rear Combination Lamp
22 Main Light Source
23 Sub Light Source

What is claimed is:

1. A vehicular lamp comprising:
a housing covered by a translucent cover so as to form a lamp chamber;
a main light source and a sub light source disposed inside the lamp chamber,
wherein the sub light source comprises a planar light-emitting body, and
wherein the planar light-emitting body is arranged in an area off to a side of a light path of the main light source.

2. The vehicular lamp according to claim 1, wherein the main light source and the sub light source are arranged in different areas of a common light source base.

3. The vehicular lamp according to claim 1, wherein the planar light-emitting body is formed surrounding the main light source.

4. The vehicular lamp according to claim 1, wherein the sub light source includes a plurality of planar light-emitting bodies that emit different colors of light.

5. The vehicular lamp according to claim 1, wherein organic EL is used for the planar light-emitting body.

6. The vehicular lamp according to claim 1, wherein the planar light-emitting body is arranged in an area that is entirely displaced from the light path of the main light source.

7. The vehicular lamp according to claim 1, wherein the planar light-emitting body is arranged so as to not block any light emitted from the main light source.

8. The vehicular lamp according to claim 1, wherein the planar light-emitting body is arranged in an area off to a side in the lateral direction of the light path of the main light source.

9. The vehicular lamp according to claim 6, wherein the planar light-emitting body is arranged in an area that is entirely displaced from the light path of the main light source off to a side in the lateral direction of the light path of the main light source.
